(19) United States
(12) Patent Application Publication
(10) Pub. No.: US 2007/0277492 A1
(43) Pub. Date: Dec. 6, 2007

(54) Self-sharpening disc mower blade

(76) Inventors: Imants Ekis, Leola, PA (US); Thomas P. Haus, Lancaster, PA (US); Timothy J. Kraus, Blakesburg, IA (US)

Correspondence Address: CNH AMERICA LLC, INTELLECTUAL PROPERTY LAW DEPARTMENT, PO BOX 1895, MS 641, NEW HOLLAND, PA, 17557, US

(21) Appl. No.: 11/443,727

(22) Filed: May 31, 2006

(51) Int. Cl. A01D 75/10

(52) U.S. Cl. 56/12.1

(57) ABSTRACT

A self-sharpening cutting blade for use in a disc-mower or mower-conditioner achieved by treating a cutting blade in a manner creates a hardness gradient within all or a portion of the blade thickness, said gradient causing the blade to exhibit self-sharpening characteristics during use.

### BACKGROUND OF THE INVENTION

The present invention relates to a self-sharpening cutting blade and, more particularly, to a self-sharpening cutting blade for use in a disc-mower or mower-conditioner and a method for making a self-sharpening blade.

Conventional cutting blades become dull with use as the cutting edge of the blade is worn down by interaction with the crop material being cut. Because dull blades are less effective and efficient, the quicker the blades become dull, the more costly it is for the farmer/operator. One approach for extending the time before a blade requires sharpening is to form the blade from self-sharpening material. Conventional self-sharpening blades are typically formed from laminated layers of materials of varying hardness and utilize wedge-shaped cutting edges. Another method avoids laminations and instead applies a hard surfacing material, such as tungsten carbide, to a comparatively softer substrate. The result is that the apex of the cutting edge is made from a material that is comparatively harder than the surrounding material. As the blade is used, the comparatively softer material surrounding the harder apex erodes at a faster rate than the hard apex which generally maintains the wedge-shape cutting edge as the blade wears.

Problems with conventional self-sharpening blades arise when delamination of the layers occurs, most frequently a concern or problem when dissimilar metals are used to form the various laminated layers. Delamination affects the structural integrity of the blade structure leading to failure of the blade. Wear patterns on hardsurfaced blades result in erosion of the softer substrate material to a point where there is little structural support for the hardsurfacing material provided by the blade substrate. Deterioration of the cutting edge apex occurs when the unsupported, brittle hardsurfacing material breaks away from the blade leaving a dull area in the cutting edge and diminishing cutting performance.

U.S. Pat. No. 3,975,891 discloses a cutting rotary blade in which an extremely hard material, such as silicon, boron, or tungsten carbide is deposited on a substrate of mild steel in various arrangements to form a wear-resistant cutting blade. As hard surfaced blades wear, the comparatively softer substrate is eroded leaving the brittle hard surface material structurally unsupported at which point it is easily chipped or broken off.

U.S. Pat. No. 6,389,699 discloses a self-sharpening blade structure comprising a layered structure of metals having differing levels of wear resistance. The layers are arranged by decreasing wear resistance extending from the cutting edge and bonded together to create a self-sharpening blade structure. Blade integrity depends on and is limited by the strength and durability of the bonding process. U.S. Pat. No. 6,207,294 addresses one solution to bonding failure in a layered self-sharpening cutting blade by disclosing a perforated structure in some of the layers. While the modified structure improves the lamination bond, it also adds complexity and expense to form a self-sharpening blade.

It would be a great advantage to provide a self-sharpening blade formed using a non-laminated blade structure that overcomes the above problems and disadvantages.

### SUMMARY OF THE INVENTION

Accordingly, it is an object of the present invention to provide a self-sharpening cutting blade formed using metal treatment processes applied to a singular base material to create a hardness gradient at least through a portion of the thickness of the blade.

It is a further object of the present invention to provide a self-sharpening cutting blade in which the desired hardness gradient may be caused by various metal treatment methods.

It is a further object of the present invention to provide a self-sharpening cutting blade that maintains high cutting quality as the blade wears.

It is a still further object of the present invention to provide a self-sharpening blade that maintains a sharper cutting edge for a longer period of operation thereby reducing input power required and costly downtime.

It is a still further object of the present invention to provide a self-sharpening blade that is durable of construction, inexpensive of manufacture, economical to maintain, and effective to use.

These and other objects are achieved by treating a cutting blade in a manner creates a hardness gradient within all or a portion of the blade thickness, said gradient causing the blade to exhibit self-sharpening characteristics during use.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a side view of a self-propelled windrower having a disc mower of the type which the self-sharpening blade will prove advantageous;

FIG. 2 is a plan view of the rotary cutting blade of the type used in a disc mower shown in FIG. 1, taken along line 2-2;

FIG. 3 is plan view of a rotary cutting blade of the type used in a rotary mower;

FIG. 4 is an end view of the rotary cutting blade of FIG. 2, taken along line 4-4, showing the hardness gradient region within the blade structure in the preferred embodiment of the invention;

FIG. 5 is an end view of a typical rotary cutting blade, similar to that shown in FIG. 4, showing the location of the hardness gradient region within the blade structure in the first alternate embodiment of the invention; and

FIG. 6 is a diagram showing blade hardness as a function of depth (thickness) from a first surface.

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience, and are determined by standing at the rear of the machine facing in its normal direction of travel. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail.

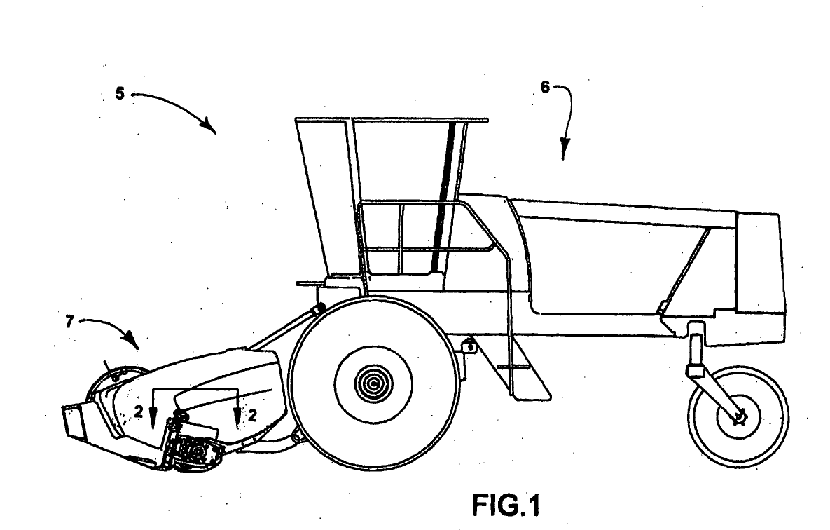

FIG. 1 shows the primary components of a typical and generally well known self-propelled agricultural windrower 5, namely a tractor 6 and a header 7. Header 7 may be of several designs, typically comprising of a feeding mechanism, a cutting mechanism, conditioning rolls, and a support apparatus, of principal interest in the present invention being the cutting mechanism. The present invention is directed to cutting mechanisms having rotary disc cutters. Rotary disc cutters are not limited to self-propelled windrowers; numerous other agricultural mowers employ the rotary disc cutter head to cut the crop, including both self-propelled and pull behind mowers.

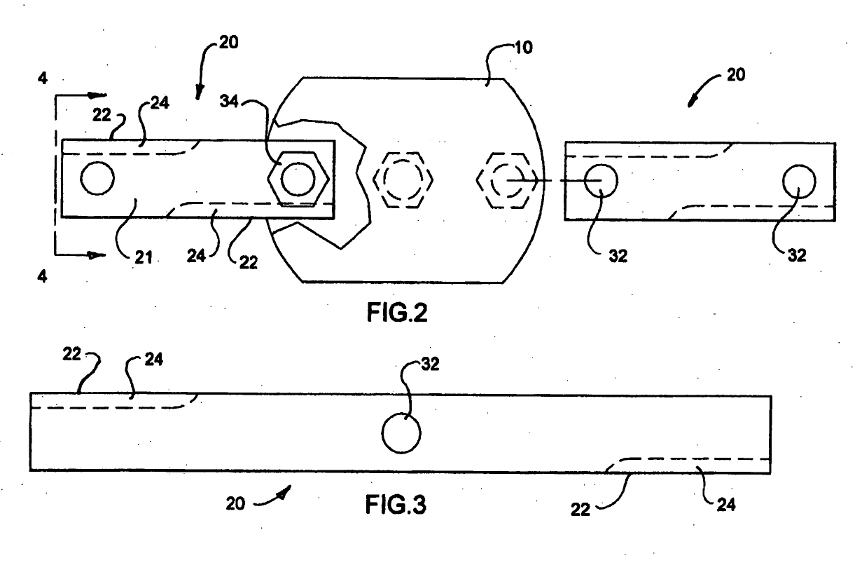

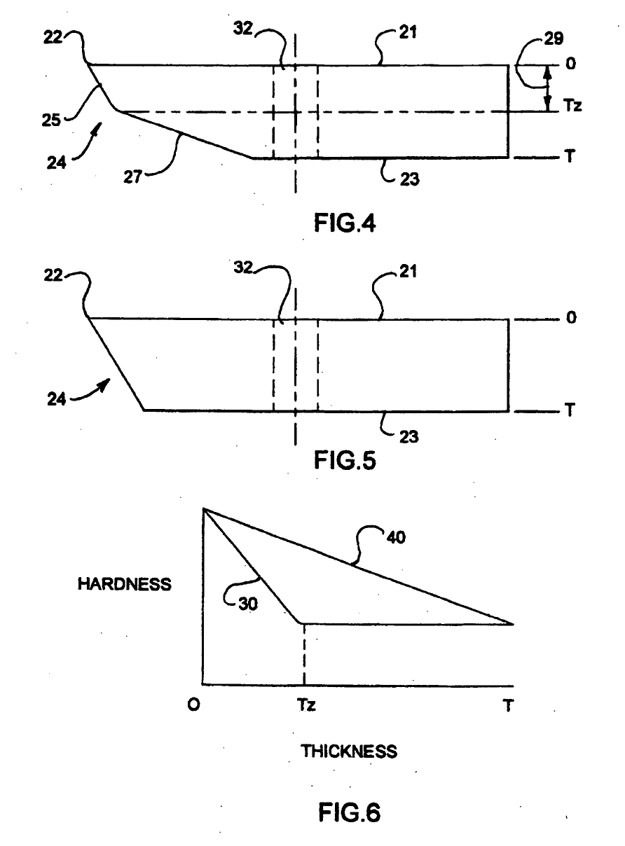

FIG. 2 shows a rotating (driven) member 10 of a disc mower to which are connected a pair of cutting blades 20. The rotary disc mower is well known in the art, typically including an elongated support bar having a plurality of gear-driven cutterhead units, represented in FIG. 2 as 10, generally evenly spaced along the length thereof. These mowers are well known in the art, and will not be described in further detail herein. Cutting blade 20 is conventionally shaped, having opposing generally planar surfaces 21, 23 (shown in FIG. 4), cutting edge 22, beveled cutting surface 24, and a mounting structure 32, typically a through hole, used to connect the blade to the rotating member. A bolt 34 or other similar fastener is used to connect the cutting blade to the rotating structure. As depicted, a pair of cutting blades are mounted in opposition on rotating member 10 to balance the forces on the rotating member during mower operation. Disc mowers using various numbers of cutting blades on the rotating members are contemplated by the present invention.

Disc mowers may include reversible cutting blades, each blade having two cutting edges 22, but wherein only one edge is actively cutting as installed. A second mounting structure 32 is provided in the cutting blade opposite to the first to allow attachment of the cutting blade in the opposite orientation to rotating member 10. Reversible cutting blades enable operators to flip the blade, thereby exposing a fresh cutting edge instead of having to resharpen the blades. While a self-sharpening blade is intended to eliminate the need to periodically sharpen the blade, cutting edges can be damaged by inadvertent contact with stones or other hard objects during mowing operations. Reversible blades can be quickly repositioned in the field allowing the mowing operation to continue with minimal interruption.

Referring to FIG. 3, shown is a cutting blade 20 as would be used on a conventional rotary mower wherein a single cutting blade having at least two cutting edges 22 is used. In a single blade application, mounting structure 32 is centrally located on the cutting blade structure so that the cutting edges rotate around a central axis that is coincident with the rotating member.

Referring now to FIG. 4, shown is an end view of the preferred embodiment of cutting blade 20 highlighting first surface 21, second surface 23, cutting edge 22 and a beveled cutting surface 24. Cutting blade 20 is made from a suitable low carbon alloy steel selected for its toughness and treatability. In a conventional cutting blade, cutting edge 22 would wear at generally the same rate as the entire cutting surface 24 as the blade material would exhibit uniform hardness throughout its thickness. In the present invention as illustrated in this view, the portion of the cutting blade material extending from first surface 21 to the line indicated by T_{z} has been treated to cause a hardness gradient, that is a portion of the blade thickness has a greater hardness than that of the remaining portion of the blade. The thickness of the treatment zone 29 varies upon the type of metallurgical treatment process used to cause the hardness gradient and the overall blade thickness. The hardest portion of the cutting blade is adjacent to and includes first surface 21, having a hardness in the range from 52 to 62 Rockwell C. Hardness generally decreases as the distance 29 from the first surfaces increases up to the distance to line T_{z} at which point is has diminished to the range from 20 to 30 Rockwell C. Hardness of the remaining portion of the blade extending from line T_{z} to second surface 23 is essentially constant, remaining generally in the range from 20 to 30 Rockwell C. Total blade thickness is not limited by this treatment approach, but total blade thickness is generally ⅜-inch or less.

As the cutting blade is used, the hardened cutting surface 25 of the blade tends to wear less than the adjacent, comparatively softer base material cutting surface 27. The differential in wear rates causes the overall profile of cutting surface 24 to maintain its original beveled profile for longer periods resulting in a self-sharpening cutting blade. The minimum thickness of the treatment zone is approximately one-third of the blade thickness so that the treated portion has sufficient structural strength to withstand impacts during cutting operation as the underlying base material is worn away. The treated zone may extend through the entire cutting blade thickness, as shown in FIG. 5, but an optimal approach is to treat only a portion of the blade thickness, typically in the range of one-third to two-thirds of the total blade thickness depending upon total blade thickness. Cutting surface 24 may exhibit slight variations in the taper between the hardened cutting surface 25 and the base material cutting surface 27 resulting from differences in hardness with the difference dependent upon the value of the hardness gradient. The transition is shown exaggerated in FIG. 4 for illustrative purposes; in application, the transition between the two zones is a gradual transition.

Hardness gradients in a material can be created by any of several methods, including metal fusion processes, differential heat treatment processes, and carburizing processes. In the preferred embodiment, a carburizing method is used in which one surface, second surface 23 as shown in FIG. 3, is coated with a material that inhibits the migration of carbon during treatment. When a low carbon steel is heated to its austenization temperature and exposed to a carbonaceous material, carbon migrates into the grain structure of the steel. The presence of carbon in the grain structure increases hardness. The coating prevents carbon migration from the coated surface resulting in a differential carbon content from first surface 21 to second surface 23. The result is that carbon content varies from a high concentration at first surface 21 to a lower concentration at second surface 23. By limiting the time the metal is exposed to the carbonaceous material, the depth of carbon migration into the material can be controlled thereby allowing a desired thickness of the treatment zone 29 to be established and creating a gradual transition in the hardness gradient between the treated portion and the base material portion.

FIG. 5 shows a first alternative embodiment of the invention in which the treated portion of the blade extends for its entire thickness. Creating a hardness gradient across the entire thickness causes cutting surface 24 to have a more uniform beveled profile and eliminates the transition in the cutting surface exhibited in the preferred embodiment as shown in FIG. 4. Total blade thickness in this embodiment is limited by the treatment processes that can effectively and efficiently cause a hardness gradient across thick material sections; therefore, thinner blades are typically used when the gradient extends through the total blade thickness.

FIG. 6 illustrates the variation in hardness as a function of thickness, measured from the first surface, in the cutting blade. First curve 30 corresponds to the preferred embodiment of the invention as shown in FIG. 4 and shown the hardness gradient existing in the blade thickness from first surface 21, shown as point 0, to the point shown as T_{z}. Once the hardness in the hardness gradient reaches to the level of the base material, it remains constant throughout the remaining cutting blade thickness, as shown in the graph progressing between point T_{z} to the total thickness, T. Second curve 40 corresponds to the first alternative embodiment of the invention as shown in FIG. 5. In this embodiment, the hardness gradient spans the entire thickness of the cutting blade and varies generally uniformly between first surface 21, point 0 on the graph, and second surface 23, point T on the graph. While both relationships show generally linear hardness gradients in the treated portion of the cutting blade, the actual hardness gradient may vary dependent upon the type treatment process used.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions.

Having thus described the invention, what is claimed is:

1. In a self-sharpening cutting blade having a plate-like structure having first and second generally planar and parallel opposing surfaces separated by a thickness dimension, and at least one cutting edge interconnecting said first and second surfaces, said structure formed from a generally rigid material having a hardness value, the improvement in said self-sharpening cutting blade comprising:
a non-stepped hardness gradient between said first and second surfaces along said thickness dimension.

2. The cutting blade of claim 1, further comprising a mechanism for mounting said blade on a rotating structure.

3. The cutting blade of claim 2, wherein said cutting blade is a knife in an agricultural disc mower.

4. The cutting blade of claim 1, wherein said blade material is low carbon alloy steel.

5. The cutting blade of claim 1, wherein said hardness gradient varies from a lower value in the range from 20 to 30 and a higher value in the range from 52 to 62 based on a Rockwell C scale.

6. The cutting blade of claim 1, wherein said thickness dimension is less than or equal to ⅜-inch.

7. The cutting blade of claim 3, wherein said blade material is low carbon alloy steel and said hardness gradient varies from a lower value in the range from 20 to 30 and a higher value in the range from 52 to 62 based on a Rockwell C scale.

8. The cutting blade of claim 7, wherein said thickness dimension is less than or equal to ⅜-inch.

9. In a self-sharpening cutting blade having a plate-like structure having first and second generally planar and parallel opposing surfaces separated by a thickness dimension, and a cutting edge interconnecting said first and second surfaces, said structure formed from a generally rigid material having a hardness value, the improvement in said self-sharpening cutting blade comprising:
a non-stepped hardness gradient including said first surface and extending along said thickness dimension toward said second surface a desired distance.

10. The cutting blade of claim 9, further comprising a mechanism for mounting said blade on a rotating structure.

11. The cutting blade of claim 10, wherein said cutting blade is a knife in an agricultural disc mower.

12. The cutting blade of claim 9, wherein said blade material is low carbon alloy steel.

13. The cutting blade of claim 9, wherein said hardness gradient varies from a lower value in the range from 20 to 30 and a higher value in the range from 52 to 62 based on a Rockwell C scale.

14. The cutting blade of claim 11, wherein said blade material is low carbon alloy steel and said hardness gradient varies from a lower value in the range from 20 to 30 and a higher value in the range from 52 to 62 based on a Rockwell C scale.

15. The cutting blade of claim 9, wherein said desired distance is in the range from one-third to two thirds of said thickness dimension.

16. The cutting blade of claim 12, wherein said hardness gradient is caused by a carburizing process.

17. The cutting blade of claim 12, wherein said hardness gradient is caused by a heat treatment process.
